(19) United States
(12) Patent Application Publication
(10) Pub. No.: US 2026/0010099 A1
(43) Pub. Date: Jan. 8, 2026

(54) IMAGE FORMING APPARATUS

(71) Applicant: Konica Minolta, Inc., Tokyo (JP)

(72) Inventors: Yuji OKUGAWA, Toyokawa-shi (JP); Yutaka MIZOTA, Toyokawa-shi (JP)

(21) Appl. No.: 19/256,938

(22) Filed: Jul. 1, 2025

(30) Foreign Application Priority Data
Jul. 4, 2024 (JP) 2024-107968

(51) Int. Cl. G03G 15/08

(52) U.S. Cl. CPC G03G 15/0898; G03G 15/0808; G03G 15/0891; G03G 2215/0827

(57) ABSTRACT

An image forming apparatus includes a developing device that via a toner bearing member disposed to face a latent image bearing member on which a latent image is formed, makes a toner adhere to the latent image to visualize the latent image. The developing device includes a drive transmission member that transmits, via an idler drive section, a drive force for driving the toner bearing member and a toner conveyance member that conveys the toner. The drive transmission member switches and performs a first operation of transmitting the drive force to the idler drive section to perform a developing process and a second operation of vibrating a prevention member that is provided in the developing device and prevents the toner from being scattered.

### CROSS REFERENCE TO RELATED APPLICATIONS

The present invention claims priority under 35 U.S.C. § 119 to Japanese Patent Application No. 2024-107968, filed on Jul. 4, 2024, the entire contents of which being incorporated herein by reference.

### BACKGROUND OF THE INVENTION

### Technical Field

The present invention relates to an image forming apparatus.

### Description of Related Art

An image forming apparatus using an electrophotographic process technology charge, with a charging device, the surface of a photosensitive drum serving as a latent image bearing member. Next, the image forming apparatus forms an electrostatic latent image on the surface of the photosensitive drum by emitting laser light based on image data. Next, the image forming apparatus visualizes the electrostatic latent image by supplying a developer to the photosensitive drum from a developing device, to form a toner image on the photosensitive drum. Next, the image forming apparatus transfers and fixes the toner image onto a sheet, to form an image on the sheet.

In such an image forming apparatus, there is a problem that the toner adhered to and accumulated on the developing device drops at the time of image formation and adheres to the photosensitive drum, or is transferred onto a transfer belt, thus causing an image defect such as image contamination.

To deal with such a problem, Japanese Unexamined Patent Publication No. H09-211974, Japanese Unexamined Patent Publication No. 2005-099239 and Japanese Unexamined Patent Publication No. 2021-184038 disclose an image forming apparatus including a vibration means that apples vibration to a housing of a developing device to suppress toner accumulation in the developing device.

### SUMMARY OF THE INVENTION

However, the vibrating means described in Japanese Unexamined Patent Publication No. H09-211974, Japanese Unexamined Patent Publication No. 2005-099239 and Japanese Unexamined Patent Publication No. 2021-184038 includes a tapping part that taps the housing of the developing device, which is a dedicated component for applying vibration to the housing of the developing device, and a movable part that moves the tapping part. In the case where the vibrating means is provided in the image forming apparatus, a space for providing the vibrating means is required in the apparatus. Therefore, there are problems that the size of the apparatus increases and the cost increases.

An object of the present invention is to provide an image forming apparatus capable of suppressing an image defect due to toner accumulated in a developing device while suppressing an increase in size or cost of the apparatus.

To achieve at least one of the abovementioned objects, according to an aspect of the present invention, an image forming apparatus reflecting one aspect of the present invention includes a developing device that via a toner bearing member disposed to face a latent image bearing member on which a latent image is formed, makes a toner adhere to the latent image to visualize the latent image,
wherein the developing device includes a drive transmission member that transmits, via an idler drive section, a drive force for driving the toner bearing member and a toner conveyance member that conveys the toner, and
wherein the drive transmission member switches and performs a first operation of transmitting the drive force to the idler drive section to perform a developing process and a second operation of vibrating a prevention member that is provided in the developing device and prevents the toner from being scattered.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 illustrates a schematic configuration of an image forming apparatus according to the present embodiment;

FIG. 2 is a block diagram illustrating a functional configuration of the image forming apparatus according to the present embodiment;

FIG. 3 is a schematic sectional view in the YZ plane in the vicinity of a developing device according to the present embodiment;

FIG. 4 is a schematic diagram of the vicinity of the developing device according to the present embodiment as viewed from above;

FIG. 5 is a schematic side view of the vicinity of the developing device according to the present embodiment;

FIG. 6A is a schematic diagram illustrating part of a drive mechanism when a drive transmission member rotates in a first direction;

FIG. 6B is a schematic diagram illustrating part of the drive mechanism when the drive transmission member rotates in the first direction;

FIG. 7 is a schematic diagram of the drive transmission member;

FIG. 8A is a schematic diagram illustrating part of the drive mechanism when the drive transmission member rotates in a second direction;

FIG. 8B is a schematic diagram illustrating part of the drive mechanism when the drive transmission member rotates in the second direction;

FIG. 9A is a schematic diagram illustrating part of the drive mechanism when the drive transmission member rotates in the second direction;

FIG. 9B is a schematic diagram illustrating part of the drive mechanism when the drive transmission member rotates in the second direction;

FIG. 10A is a schematic diagram illustrating part of the drive mechanism when the drive transmission member rotates in the second direction;

FIG. 10B is a schematic diagram illustrating part of the drive mechanism when the drive transmission member rotates in the second direction;

FIG. 11A is a schematic diagram illustrating part of the drive mechanism when the drive transmission member rotates in the second direction;

FIG. 11B is a schematic diagram illustrating part of the drive mechanism when the drive transmission member rotates in the second direction;

FIG. 12A is a schematic diagram illustrating part of the drive mechanism when the drive transmission member rotates in the second direction;

FIG. 12B is a schematic diagram illustrating part of the drive mechanism when the drive transmission member rotates in the second direction;

FIG. 13A is a schematic diagram illustrating part of the drive mechanism when the drive transmission member rotates in the second direction;

FIG. 13B is a schematic diagram illustrating part of the drive mechanism when the drive transmission member rotates in the second direction;

FIG. 14 is a schematic diagram of the vicinity of the developing device according to a second embodiment as viewed from above;

FIG. 15 is a block diagram illustrating a control function in a rotation restricting operation according to a modification example of the second embodiment;

FIG. 16 is a schematic diagram of the vicinity of the developing device according to the modification example of the second embodiment as viewed from above;

FIG. 17 is a schematic perspective view of the vicinity of a solenoid and a protrusion member according to the modification example of the second embodiment; and

FIG. 18 is a flowchart of a rotation control process according to the modification example of the second embodiment.

### DETAILED DESCRIPTION

Hereinafter, one or more embodiments of the present invention will be described in detail with reference to the drawings. However, the scope of the invention is not limited to the disclosed embodiments or the illustrated examples.

### First Embodiment

### 1. Configuration of Image Forming Apparatus 1

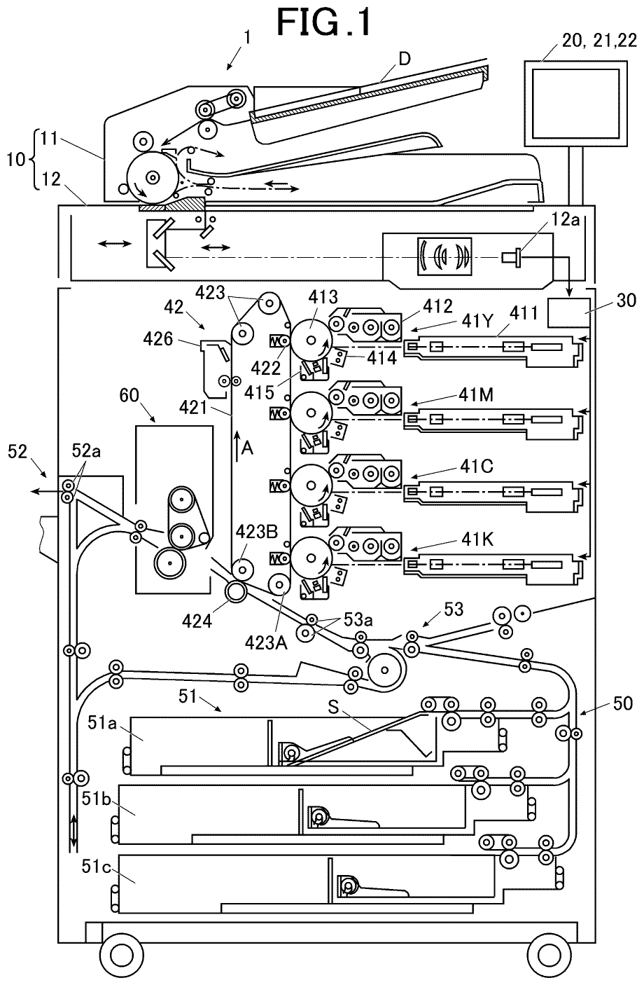

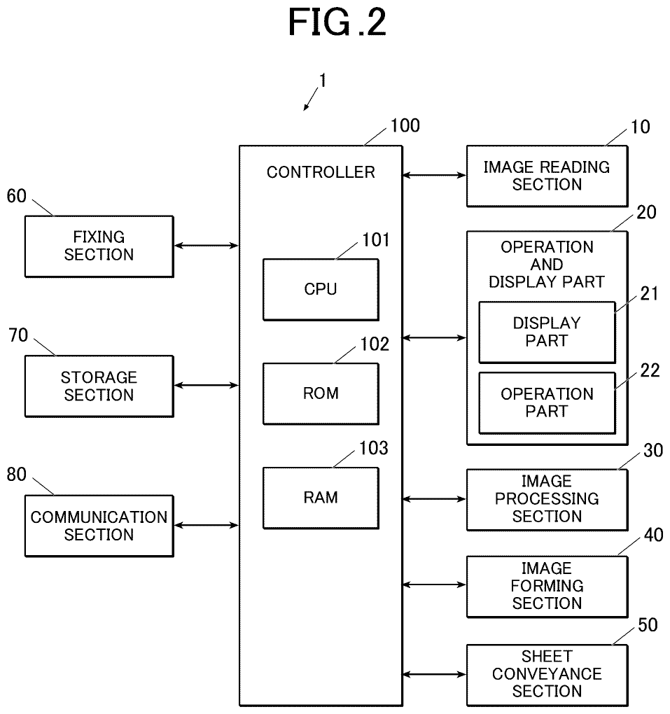

FIG. 1 schematically illustrates an overall configuration of an image forming apparatus 1 according to an embodiment of the present invention. FIG. 2 is a block diagram illustrating the main functional configuration of the image forming apparatus 1 according to the embodiment.

The image forming apparatus 1 illustrated in FIG. 1 and FIG. 2 is an intermediate transfer method color image forming apparatus utilizing an electrophotographic process technology. The image forming apparatus 1 transfers (primary transfer) toner images of respective colors of Y (yellow), M (magenta), C (cyan), and K (black) formed on photosensitive drums 413 to an intermediate transfer belt 421. Next, after superimposing the toner images of the four colors on the intermediate transfer belt 421, the image forming apparatus 1 transfers the superimposed toner image onto a sheet S (secondary transfer), thereby forming an image.

The image forming apparatus 1 is of a tandem-system type in which the photosensitive drums 413 corresponding to the four colors of YMCK are arranged in series in a traveling direction of the intermediate transfer belt 421, and the toner images of the respective colors are sequentially transferred to the intermediate transfer belt 421.

As illustrated in FIG. 2, the image forming apparatus 1 includes an image reading section 10, an operation and display part 20, an image processing section 30, an image forming section 40, a sheet conveyance section 50, a fixing section 60, a storage section 70, a communication section 80, and a controller 100 (hardware processor).

The controller 100 includes a central processing unit (CPU) 101, a read only memory (ROM) 102, a random access memory (RAM) 103, and the like.

The CPU 101 reads a program corresponding to a process content from the ROM 102, loads the program to the RAM 103, and centrally controls the operation of each block of the image forming apparatus 1 illustrated in FIG. 2 in cooperation with the loaded program. The image reading section 10 includes an automatic document sheet feed device 11 called an automatic document feeder (ADF), a document image scanning device 12 (scanner), and the like.

The automatic document sheet feed device 11 conveys a document D placed on a document tray by a conveyance mechanism and sends the document D to the document image scanning device 12. The automatic document sheet feed device 11 can continuously read images of a large number of documents D placed on the document tray at once.

The document image scanning device 12 optically scans a document conveyed from the automatic document sheet feed device 11 onto a contact glass or a document placed on the contact glass. Next, the document image scanning device 12 reads a document image by forming an image of reflected light from the document on a light receiving surface of a charge coupled device (CCD) sensor 12a. The image reading section 10 generates input image data based on the reading result by the document image scanning device 12. The image processing section 30 performs predetermined image processing on the input image data.

The operation and display part 20 includes, for example, a liquid crystal display (LCD) provided with a touch screen, and functions as a display part 21 and an operation part 22.

The display part 21 displays various kinds of operation screens, the state of an image, the operating states of functions, and the like in accordance with display control signals input from the controller 100.

The operation part 22 includes various kinds of operation keys such as a numeric keypad and a start key and receives various kinds of input operations made by a user and outputs operation signals to the controller 100.

The image processing section 30 includes a circuit that performs digital image processing on image data of an input job (input image data) in accordance with the initial settings or user settings. For example, the image processing section 30 performs gradation correction on the basis of gradation correction data under the control of the controller 100. The image processing section 30 performs, on the input image data, not only the gradation correction but also various kinds of correction such as color correction and shading correction, compression, and the like.

The image forming section 40 forms an image with color toners of a Y component, an M component, a C component, and a K component on the basis of the input image data subjected to the image processing by the image processing section 30.

The image forming section 40 includes image forming units 41Y, 41M, 41C, and 41K, an intermediate transfer unit 42, and the like.

The image forming units 41Y, 41M, 41C, and 41K for the Y component, the M component, the C component, and the K component, respectively, have the same configuration. For convenience of illustration and description, common constituent elements are denoted by the same reference signs, and when they are distinguished from each other, Y, M, C, or K is added to the reference signs. In FIG. 1, only the constituent elements of the image forming unit 41Y for the Y component are provided with reference signs, and the constituent elements of the other image forming units 41M, 41C, and 41K are not provided with reference signs.

The image forming unit 41 includes an exposure device 411, a developing device 412, a photosensitive drum 413, a charging device 414, a drum cleaning device 415, and the like.

The photosensitive drum 413 is, for example, an organic photoreceptor in which a photosensitive layer that is a resin containing an organic photoconductor is formed on the outer peripheral surface of a drum-shaped metal substrate. The photosensitive drum 413 functions as a latent image bearing member.

The controller 100 controls drive current supplied to a drive motor (not illustrated) that rotates the photosensitive drum 413, thereby rotating the photosensitive drum 413 at a constant circumferential velocity.

The charging device 414 is, for example, a charging charger, and uniformly charges the surface of the photosensitive drum 413 to a negative polarity by generating corona discharge.

The exposure device 411 includes, for example, a semiconductor laser and irradiates the photosensitive drum 413 with laser light corresponding to an image of its corresponding color component. Thus, the exposure device 411 forms an electrostatic latent image of a color component in an image area of the surface of the photosensitive drum 413, the image area being irradiated with the laser light, due to a potential difference from a background region.

The developing device 412 is a developing device of a two-component developing method and forms a toner image by visualizing an electrostatic latent image by making toner of a color component adhere to the surface of the photosensitive drum 413. Details will be described later.

The cleaning device 415 includes a cleaning blade that comes in sliding contact with the surface of the photosensitive drum 413. The cleaning device 415 removes the transfer residual toner remaining on the surface of the photosensitive drum 413 after primary transfer.

The intermediate transfer unit 42 includes an intermediate transfer belt 421, primary transfer rollers 422, support rollers 423, a secondary transfer roller 424, and a belt cleaning device 426.

The intermediate transfer belt 421 is an endless belt and stretched in a loop shape around the support rollers 423. At least one of the support rollers 423 is a drive roller, and the others are driven rollers. For example, preferably, a roller 423A arranged more on a downstream in a belt travel direction than a primary transfer roller 422 for the K component is a drive roller. This makes it easier to maintain the running speed of the belt at primary transfer sections constant. Rotation of a roller 423A causes the intermediate transfer belt 421 to run in a direction indicated by an arrow A at a constant speed.

The primary transfer rollers 422 are arranged on the inner peripheral surface side of the intermediate transfer belt 421 so as to face the photosensitive drums 413 for the respective color components.

The intermediate transfer unit 42 presses the primary transfer rollers 422 against the photosensitive drums 413 with the intermediate transfer belt 421 in between. Thus, the intermediate transfer unit 42 forms primary transfer nips for transferring the toner images from the photosensitive drums 413 to the intermediate transfer belt 421.

The secondary transfer roller 424 is disposed on the outer peripheral surface side of the intermediate transfer belt 421 so as to face a backup roller 423B disposed on the downstream side of the roller 423A in the belt running direction.

The intermediate transfer unit 42 presses the secondary transfer roller 424 against the backup roller 423B with the intermediate transfer belt 421 in between. Thus, the intermediate transfer unit 42 forms a secondary transfer nip for transferring the toner image(s) onto the sheet S from the intermediate transfer belt 421.

The intermediate transfer unit 42 primarily transfers the toner images on the photosensitive drums 413 sequentially in a superimposed manner onto the intermediate transfer belt 421 when the intermediate transfer belt 421 passes through the primary transfer nips. Specifically, the intermediate transfer unit 42 applies a primary transfer bias to the primary transfer rollers 422 and applies a charge having a polarity opposite to that of the toners to, of the intermediate transfer belt 421, the side that comes into contact with the primary transfer rollers 422. Thus, the intermediate transfer unit 42 electrostatically transfers the toner images onto the intermediate transfer belt 421.

Thereafter, when the sheet S passes through the secondary transfer nip, the intermediate transfer unit 42 secondarily transfers the toner image(s) on the intermediate transfer belt 421 to the sheet S. Specifically, the intermediate transfer unit 42 applies a secondary transfer bias to the secondary transfer roller 424, and applies a charge having a polarity opposite to that of the toners to, of the sheet S, the side that comes into contact with the secondary transfer roller 424. Thus, the intermediate transfer unit 42 electrostatically transfers the toner image(s) onto the sheet S. The sheet conveyance section 50 conveys the sheet S having the toner image transferred thereto toward the fixing section 60.

The cleaning device 426 includes a cleaning blade that comes into sliding contact with the surface of the intermediate transfer belt 421. The belt cleaning device 426 removes the transfer residual toner remaining on the surface of the intermediate transfer belt 421 after secondary transfer.

The intermediate transfer unit 42 may have a configuration in which, instead of the secondary transfer roller 424, a secondary transfer belt is stretched in a loop shape around support rollers including a secondary transfer roller. The above-described configuration is a so-called belt-type secondary transfer unit.

The fixing section 60 heats and pressurizes the conveyed sheet S on which the toner image(s) has been secondary transferred, thereby fixing the toner image on the sheet S.

The sheet conveyance section 50 includes a sheet feed section 51, a sheet ejection section 52, a conveyance route section 53, and the like.

Sheets S (standard sheets, special sheets, etc.) identified on the basis of the basis weight, size, and the like are stored type by type in three sheet feed tray units 51a to 51c included in the sheet feed section 51.

The conveyance route section 53 has a plurality of conveyance roller pairs such as a registration roller pair 53a.

The sheet conveyance section 50 feeds the sheets S stored in the sheet feed tray units 51a to 51c one by one from the top and conveys them to the image forming section 40 by the conveyance route section 53. At this time, a registration roller section in which the registration roller pair 53a is arranged corrects the inclination of the feed sheet S and also adjusts the conveyance timing. Next, the image forming section 40 collectively secondary transfers the toner images on the intermediate transfer belt 421 to one side of the sheet S. Next, the fixing section 60 fixes the secondary transferred toner image onto the sheet. Next, the sheet conveyance section 50 ejects the sheet S with the image formed to the outside of the apparatus by the sheet ejection section 52 having sheet ejection rollers 52a.

The storage section 70 includes, for example, a nonvolatile semiconductor memory and a hard disk drive. The storage section 70 stores various types of data such as various types of setting information related to the image forming apparatus 1.

The communication section 80 includes a communication control card such as a local area network (LAN) card. The communication section 80 transmits and receives various kinds of data to and from an external device (e.g., personal computer) connected to a communication network such as a LAN or a wide area network (WAN).

### 2. Configuration of Developing Device 412

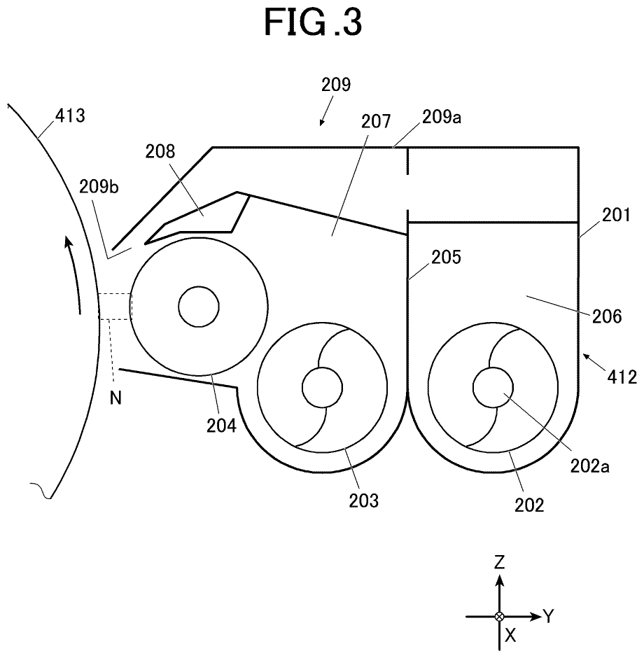

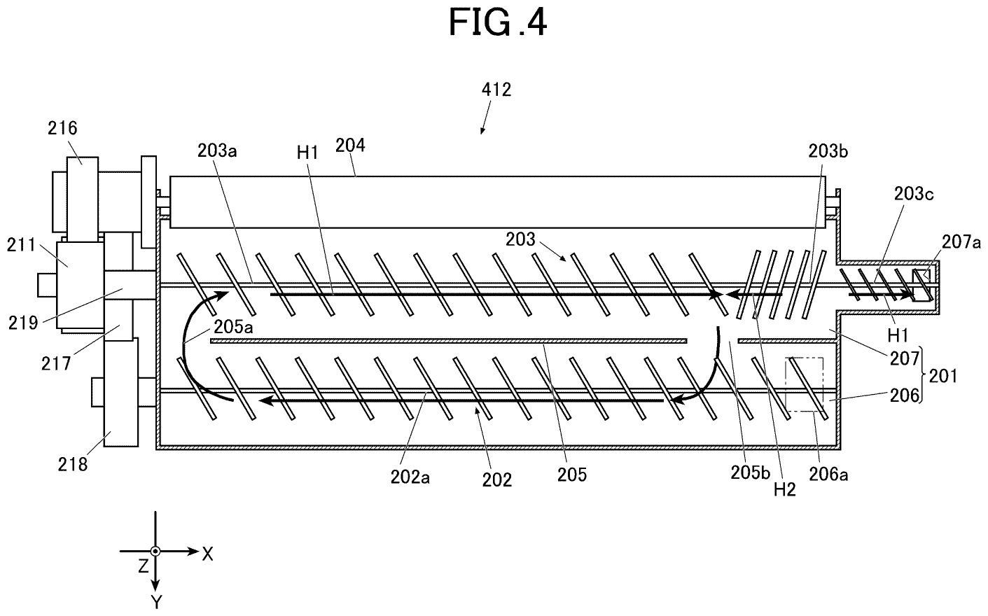

Next, the configuration of the developing device 412 will be described in detail with reference to FIG. 3 and FIG. 4. FIG. 3 is a schematic sectional view in the YZ plane in the vicinity of the developing device 412. FIG. 4 is a schematic diagram of the vicinity of the developing device 412 as viewed from above.

The developing device 412 is of a two-component developing method, and develops an electrostatic latent image formed on the photosensitive drum 413 using a two-component developer containing a toner and a carrier. Thus, the developing device 412 forms a toner image on the photosensitive drum 413.

The developing device 412 includes a developer housing 201.

The developer housing 201 stores a developer containing a toner and a carrier. The developer housing 201 includes a toner conveyance member 202, a toner supply member 203, and a developing roller 204 therein. The developing roller 204 functions as a toner bearing member.

In the example illustrated in FIG. 3 and FIG. 4, a direction parallel to a rotation axis (shaft) 202a of the toner conveyance member 202 is the X-axis direction, a direction horizontal and orthogonal to the X-axis direction is the Y-axis direction, and a vertical direction orthogonal to both the X-axis direction and the Y-axis direction is the Z-axis direction.

The toner conveyance member 202 and the toner supply member 203 are arranged along the axis direction (X-axis direction) of the developing roller 204. Each of the toner conveyance member 202 and the toner supply member 203 is a screw-shaped member including a central axis and a blade body spirally formed around the central axis.

The developer housing 201 includes a housing chamber 206 that houses the toner conveyance member 202, and a housing chamber 207 that houses the toner supply member 203. The housing chamber 206 and the housing chamber 207 are partitioned by a partition wall 205 disposed along the XZ plane.

The toner conveyance member 202 and the toner supply member 203 are arranged in parallel with the partition wall 205 in between.

As illustrated in FIG. 4, the toner supply member 203 includes a supplying screw 203a, a reverse winding screw 203b, and a discharging screw 203c that are coaxially arranged in this order.

The supplying screw 203a supplies a developer to the developing roller 204.

In the following description, a direction in which a developer is conveyed by positive rotation of the supplying screw 203a is referred to as a “first conveyance direction H1”, and a direction opposite thereto is referred to as a “second conveyance direction H2”.

The reverse winding screw 203b is provided on the positive side of the X-axis direction of the supplying screw 203a and conveys the developer in a direction opposite to the supplying screw 203a.

The discharging screw 203c is provided on the positive side of the X-axis direction of the reverse winding screw 203b.

The supplying screw 203a conveys the developer in the first conveyance direction H1 during its positive rotation. The reverse winding screw 203b conveys the developer in the second conveyance direction H2 during its normal rotation. The discharging screw 203c conveys, during its positive rotation, the developer in the first conveyance direction H1, which is the same as the supplying screw 203a. Thus, the developer conveyed by the positive rotation of the supplying screw 203a is hardly conveyed to the positive side of the X-axis direction of the reverse winding screw 203b. In this case, the developer conveyed during the normal rotation of the supplying screw 203a does not advance to the reverse winding screw 203b side but is conveyed to the toner conveyance member 202 side by the route being bent.

As illustrated in FIG. 4, the housing chamber 207 includes a discharge port 207a for discharging the developer, at the end part on the positive side of the X-axis direction.

The discharge port 207a is open downward from the inner bottom part of the housing chamber 207. The developer discharged from the discharge port 207a drops and is stored in a waste developer storage section (not illustrated).

The toner conveyance member 202 conveys the developer in the direction opposite to the supplying screw 203a by being rotationally driven in the positive rotation direction.

As shown in FIG. 4, the housing chamber 206 includes a supply port 206a for supplying the developer into the developer housing 201, namely, for replenishing the developer housing 201 with the developer, at the end part on the positive side of the X-axis direction.

Above the supply port 206a of the developer housing 201, a supply section (not illustrated) is arranged which includes a developer storage section in which the developer for supply is stored and a conveyance mechanism which conveys the developer for supply from the developer storage section. The developer for supply is supplied to the housing chamber 206 from above through the supply port 206a. The supplied developer for supply joins the developer circulating through an annular circulation route in the developer housing 201 and is conveyed by the toner conveyance member 202.

As illustrated in FIG. 4, the partition wall 205 has openings 205a and 205b.

The opening 205a delivers the developer from the toner conveyance member 202 to the supplying screw 203a.

The opening 205b delivers the developer from the supplying screw 203a to the toner conveyance member 202.

Thus, the developer circulates between the housing chamber 206 and the housing chamber 207. Some of the developer conveyed by the toner conveyance member 203 is supplied to the developing roller 204, and the developer is magnetically attracted to the outer peripheral surface of the developing roller 204.

The image forming apparatus 1 replenishes the toner decreased by consumption at the time of image formation by supplying the developer from the supply port 206a. At the same time, the image forming apparatus 1 discharges the developer through the discharge port 207a. Thus, the image forming apparatus 1 replaces the deteriorated carrier in the developer housing 201 with a new carrier to be supplied, thereby suppressing deterioration of the carrier circulating in the developer housing 201.

The rotation ratio of the toner supply member 203 and the toner conveyance member 202 during the positive rotation, the opening widths of the openings 205a and 205b, and the winding number of the reverse winding screw 203b are set to values with which the amount of developer in the developer housing 201 can be maintained at a predetermined amount.

In the present embodiment, the number of rotations (rotational speed) of the toner supply member 203 is 466 rpm, and the number of rotations of the toner conveyance member 202 is 491 rpm. The rotational speed ratio of the toner supply member 203 of the toner conveyance member 202 is 0.95:1. In the present embodiment, the opening widths of the openings 205a and 205b are both 32.5 mm, and the winding number of the reverse winding screw 203b is 7.

The developing roller 204 faces the photosensitive drum 413 at an opening of the developer housing 201. For example, the developing roller 204 conveys the developer attracted on the outer peripheral surface toward a developing nip (or developing region) N that is a part facing the photosensitive drum 413. The developing roller 204 supplies the toner to the photosensitive drum 413 at the developing nip N.

The developing device 412 includes a prevention member 208 provided above the developing roller 204.

The prevention member 208 suppresses smoke (scattered toner) due to the developer, which is generated during rotation of the developing roller 204.

The developing device 412 includes a suction section 209 for sucking the scattered toner generated between the photosensitive drum 413 and the developing roller 204.

The suction section 209 includes a duct 209a disposed along the upper-side outer surface of the developer housing 201 and a fan (not illustrated). A suction port 209b that is a tip end part of the duct 209a is installed at a position close to the developing roller 204, on the photosensitive drum 413. The fan included in the suction section 209 sucks air inside the duct 209a. Thus, the scattered toner generated between the photosensitive drum 413 and the developing roller 204 is taken into the duct 209b from the suction port 209a. After being conveyed through the duct 209a, the scattered toner is collected in a collection tank (not shown).

The controller 100 controls start and stop of rotation of the fan included in the suction section 209, change in rotational speed of the fan, and the like.

There is a problem that in the suction section 209, the toner is accumulated on the wall surface of the duct 209a or the like, and the accumulated toner spills onto the photosensitive drum 413 or the sheet, thus causing an image defect in which the inside of the image forming apparatus 1 is contaminated or the image is made dirty.

In particular, in the vicinity of the suction port 209b, the laminar flow generated by the rotation of the developing roller 204 and the laminar flow generated by the rotation of the photosensitive drum 413 intersect with each other, and a spiral airflow is generated. Therefore, even if the speed of air suction at the suction section 209 is increased, toner cannot be completely sucked/collected in the vicinity of the suction port 209b and is likely to be accumulated. The vicinity of the suction port 209b is, for example, a tip end part of the prevention member 208 (an end part on the photosensitive drum 413 side).

In the present embodiment, the image forming apparatus 1 crushes the toner accumulated on the prevention member 208 by applying vibration to the prevention member 208. Next, the image forming apparatus 1 collects the crushed toner by suction using the suction section 209, or make the crushed toner adhere to the developing roller 204, thereby reducing the toner accumulated on the prevention member 208. Thus, the image forming apparatus 1 suppresses the image defect due to spillage of the accumulated toner onto the photosensitive drum 413 or the sheet.

### 3. Configuration of Drive Mechanism 210

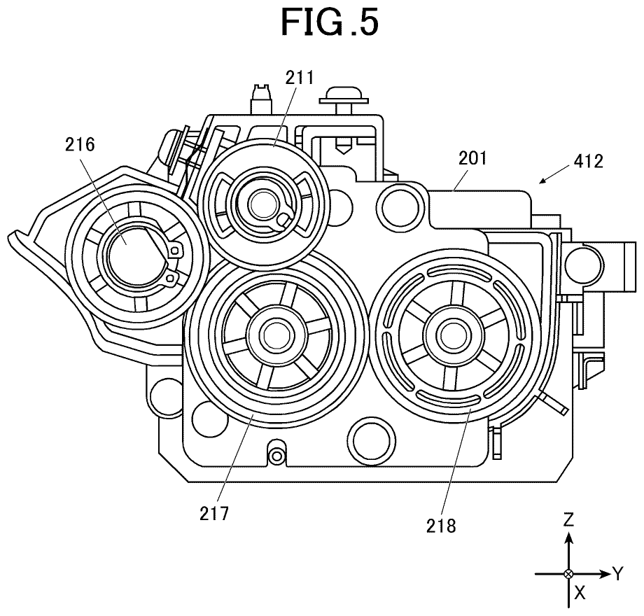

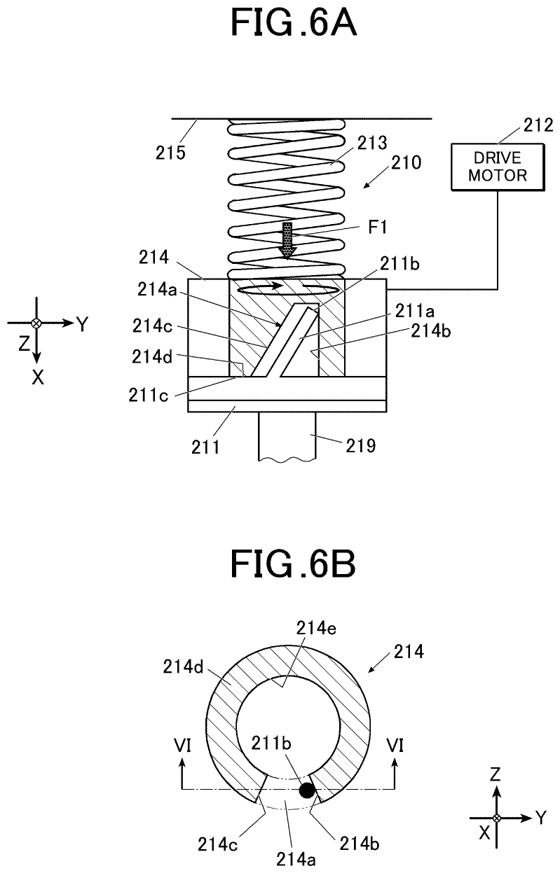

FIG. 5 is a schematic side view of the vicinity of the developing device 412, and FIG. 6A is a schematic diagram illustrating part of the configuration of a drive mechanism 210 included in the developing device 412.

As illustrated in FIG. 4 to FIG. 6B, the drive mechanism 210 includes an idler gear 211 (idler drive section), a drive motor 212, an elastic member 213, a drive transmission member 214, a developing roller gear 216, a toner supply member gear 217, and a toner conveyance member gear 218.

The developing roller gear 216 transmits to the developing roller 204, a rotational drive force for rotationally driving the developing roller 204.

The toner supply member gear 217 transmits to the toner supply member 203, a rotational drive force for rotationally driving the toner supply member 203.

The toner conveyance member gear 218 transmits to the toner conveyance member 202, a rotational drive force for rotationally driving the toner conveyance member 202.

The idler gear 211 transmits a rotational drive force output from the drive motor 212 to the developing roller gear 216, the toner supply member gear 217 and the toner conveyance member gear 218 via the drive transmission member 214.

As illustrated in FIG. 6A, the idler gear 211 includes an engagement portion 211a that protrudes toward the negative side of the X-axis direction at a predetermined angle with respect to the X-axis direction.

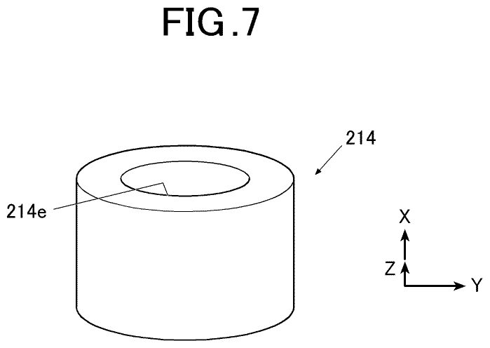

The drive transmission member 214 is a substantially columnar member as shown in FIG. 7.

FIG. 6B is a schematic diagram illustrating a positional relationship between the drive transmission member 214 and an end part 211b of the engagement portion 211a as viewed from the negative side of the X-axis direction. The shaded part of the drive transmission member 214 illustrated in FIG. 6A is a sectional view taken along line VI-VI illustrated in FIG. 6B.

Under the control of the controller 100, the drive motor 212 rotates the drive transmission member 214 about a rotation axis parallel to the X-axis direction by switching a first direction and a second direction. The first direction is a positive rotation direction and is clockwise when viewed from the negative side of the X-axis direction. The second direction is a reverse rotation direction and is counterclockwise when viewed from the negative side of the X-axis direction opposite to the first direction.

The elastic member 213 is a spring or the like provided along the X-axis direction between an inner wall surface 215 of a housing of the image forming apparatus 1 and the drive transmission member 214. The elastic member 213 is extendable in the X-axis direction.

The drive transmission member 214 includes an engaged portion 214a which is engaged with the engagement portion 211a of the idler gear 211 on a facing surface 214d which faces the idler gear 211.

The engaged portion 214a has a substantially rectangular trapezoidal shape in the XY plane. The engaged portion 214a includes a parallel part 214b that is parallel to the X-axis and an inclined part 214c that is inclined at a predetermined angle with respect to the X-axis.

The angle at which the inclined part 214c is inclined with respect to the X-axis is substantially the same as the angle at which the engagement portion 211a of the idler gear 211 is inclined with respect to the X-axis, and the inclined part 214c and the engagement portion 211a are parallel to each other.

As shown in FIG. 7, the drive transmission member 214 has a through hole 214e at the center in the YZ plane. The through hole 214e penetrates the drive transmission member 214 in the X-axis direction. The rotation shaft of the drive transmission member 214 is inserted into the through hole 214e.

### 4. Rotation Operation in First Direction

Next, the operation of the developing device 412 in a case where the drive transmission member 214 rotates in the first direction will be described.

In the state illustrated in FIG. 6A, the drive transmission member 214 is biased toward the idler gear 211 by elastic force F1 of the elastic member 213. The engagement portion 211a of the idler gear 211 and the engaged portion 214a of the drive transmission member 214 are in an engaged state. The end part 211b of the engagement portion 211a is in contact with the parallel part 214a of the engaged portion 214b. The facing surface 214d of the drive transmission member 214 is in contact with, of the idler gear 211, a facing surface 211c which is a surface facing the drive transmission member 214.

In this state, the controller 100 drives the drive motor 212 such that the drive transmission member 214 rotates in the first direction. The rotational drive force of the drive motor 212 is transmitted to the idler gear 211 via the engaged portion 214a of the drive transmission member 214 and the engagement portion 211a of the idler gear 211 that are in the engaged state.

At this time, the drive transmission member 214 transmits the rotational drive force of the drive motor 212 to the developing roller 204 via the developing roller gear 216 that meshes with the idler gear 211.

The drive transmission member 214 transmits the rotational drive force of the drive motor 212 to the toner supply member 203 via the toner supply member gear 217 that meshes with the idler gear 211.

The drive transmission member 214 transmits the rotational drive force of the drive motor 212 to the toner conveyance member 202 via the toner conveyance member gear 218 that meshes with the toner supply member gear 217.

At this time, a conveyance force with which the toner conveyance member 202 conveys the developer by rotating in the first direction by the rotational drive force of the drive motor 212 is greater than a load that the toner conveyance member 202 receives from the developer stored in the housing chamber 206. Therefore, the toner conveyance member 202 rotates in the first direction about the rotation axis 202a. Thus, the developer stored in the housing chamber 206 is conveyed from the positive side of the X-axis direction to the negative side of the X-axis direction. This is the case where the drive transmission member 214 transmits, to the idler gear 211, the rotational drive force of the drive motor 212 that is greater than the rotational load of the idler gear 211. At this time, the idler gear 211 rotates in the first direction about an idler shaft 219 that is parallel to the X-axis direction.

In this case, the developing roller 204 is rotated by the rotational drive force of the drive motor 212 about the rotation axis parallel to the X-axis direction counterclockwise when viewed from the negative side of the X-axis direction. The developing roller 204 supplies toner to the photosensitive drum 413 at the developing nip N by rotating.

The toner supply member 203 is rotated by the rotational drive force of the drive motor 212 about the rotation axis parallel to the X axis direction counterclockwise when viewed from the negative side of the X axis direction. The toner supply member 203 supplies developer to the developing roller 204 by rotating.

In the rotation operation in the first direction, the drive transmission member 214 and the idler gear 211 rotate in the first direction with the engaged portion 214a and the engagement portion 211a engaged with each other.

As described above, in the rotation operation in the first direction, the drive transmission member 214 transmits the rotational drive force of the drive motor 212 to the idler gear 211, thereby performing a first operation of performing a developing process.

The controller 100 rotates the drive transmission member 214 in the first direction in the state in which the engaged portion 214a of the drive transmission member 214 and the engagement portion 211a of the idler gear 211 are engaged with each other. Thus, the controller 100 causes the drive transmission member 214 to, as the first operation, transmit a drive force greater than the rotational load of the idler gear 211 to the idler gear 211 to rotate the idler gear 211 in the first direction, thereby performing the developing process.

The drive transmission member 214 transmits the rotational drive force of the drive motor 212 to the idler gear 211 via the engaged portion 214a of the drive transmission member 214 and the engagement portion 211a of the idler gear 211 that are in the engaged state in the first operation.

### 5. Rotation Operation in Second Direction

Next, the operation of the developing device 412 in a case where the drive transmission member 214 rotates in the second direction will be described.

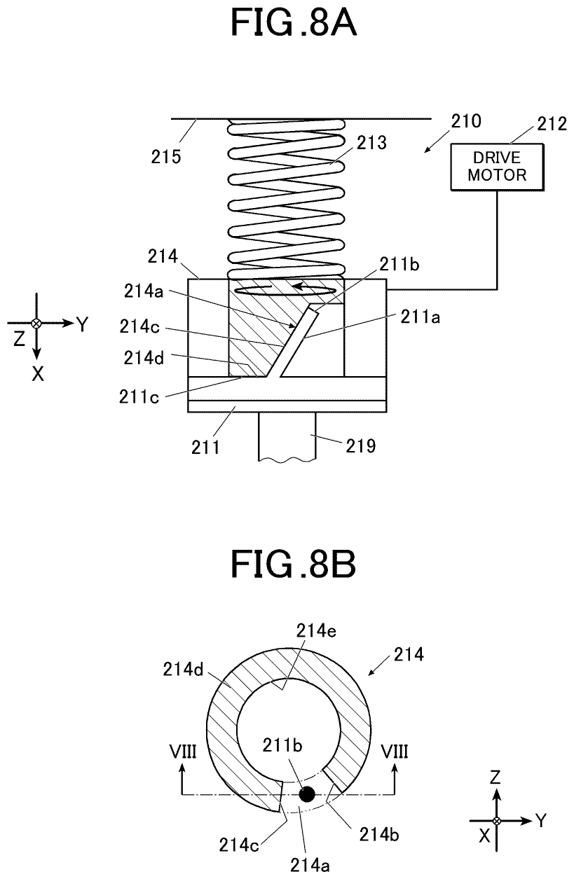

FIG. 8A to FIG. 13B are schematic diagrams illustrating part of the configuration of the drive mechanism 210 in a case where the drive transmission member 214 rotates in the second direction.

The controller 100 drives the drive motor 212 such that the drive transmission member 214 rotates in the second direction in the state in which the engagement portion 211a of the idler gear 211 and the engaged portion 214a of the drive transmission member 214 are engaged with each other.

When the drive transmission member 214 rotates in the second direction, the engagement portion 211a contacts the inclined part 214c of the engaged portion 214a, as illustrated in FIG. 8A. The shaded part of the drive transmission member 214 illustrated in FIG. 8A is a sectional view taken along line VIII-VIII illustrated in FIG. 8B.

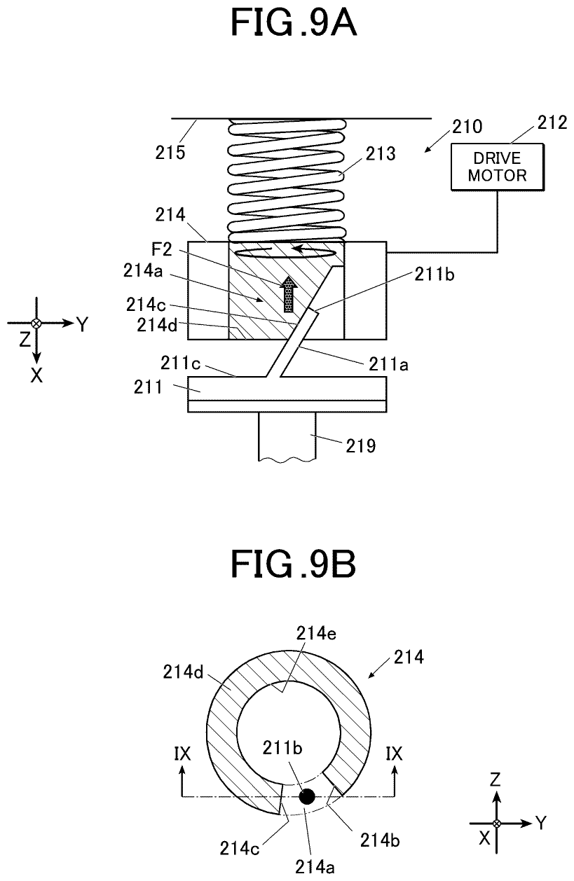

FIG. 9A and FIG. 9B illustrate a state in which the controller 100 has further rotated the drive transmission member 214 in the second direction from the state illustrated in FIG. 8A and FIG. 8B. In the present embodiment, when the drive transmission member 214 rotates in the second direction, a load that the toner conveyance member 202 receives from the developer stored in the housing chamber 206 is greater than a conveyance force with which the toner conveyance member 202 conveys the developer by rotating in the second direction. That is, the rotational load of the idler gear 211 in the rotation operation in the second direction is greater than the rotational drive force by the drive motor 212. Therefore, the idler gear 211 does not rotate and remains stopped.

At this time, as illustrated in FIG. 9A, the engaged portion 214a receives force F2 from the engagement portion 211a at the inclined part 214c. The shaded part of the drive transmission member 214 illustrated in FIG. 9A is a sectional view taken along line IX-IX illustrated in FIG. 9B.

When the engaged portion 214a receives the force F2, the drive transmission member 214 moves to the negative side of the X-axis direction, and the facing surface 214d of the drive transmission member 214 and the facing surface 211c of the idler gear 211 are separated from each other. Thus, the elastic member 213 contracts in the X-axis direction.

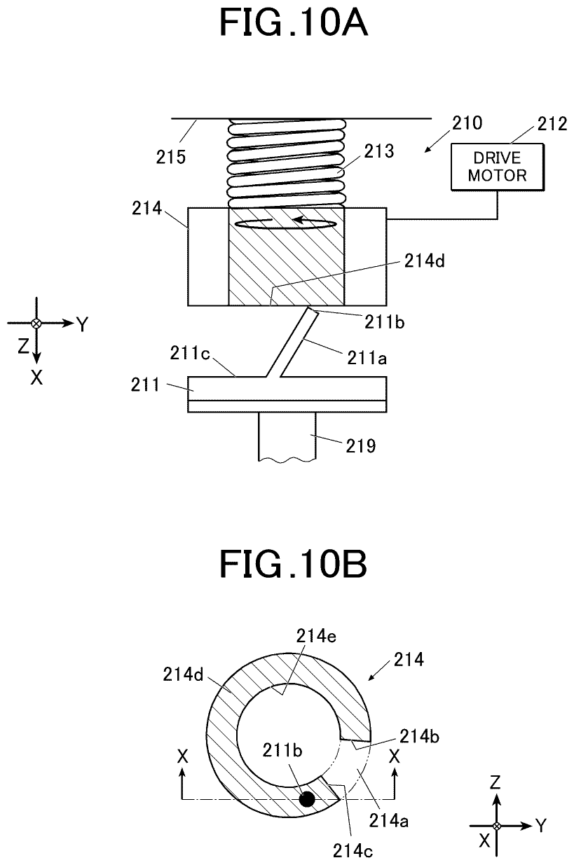

FIG. 10A and FIG. 10B illustrate a state in which the controller 100 has further rotated the drive transmission member 214 in the second direction from the state illustrated in FIG. 9A and FIG. 9B. As shown in FIG. 10A, the drive transmission member 214 further moves to the negative side of the X-axis direction. The shaded part of the drive transmission member 214 illustrated in FIG. 10A is a sectional view taken along line X-X illustrated in FIG. 10B.

When the drive transmission member 214 further moves to the negative side of the X-axis direction, the engagement portion 211a of the idler gear 211 and the engaged portion 214a of the drive transmission member 214 are disengaged from each other. In addition, the end part 211b of the engagement portion 211a contacts the facing surface 214d of the drive transmission member 214. The elastic member 213 further contracts in the X-axis direction. The elastic member 213 illustrated in FIG. 10A is in the most contracted state.

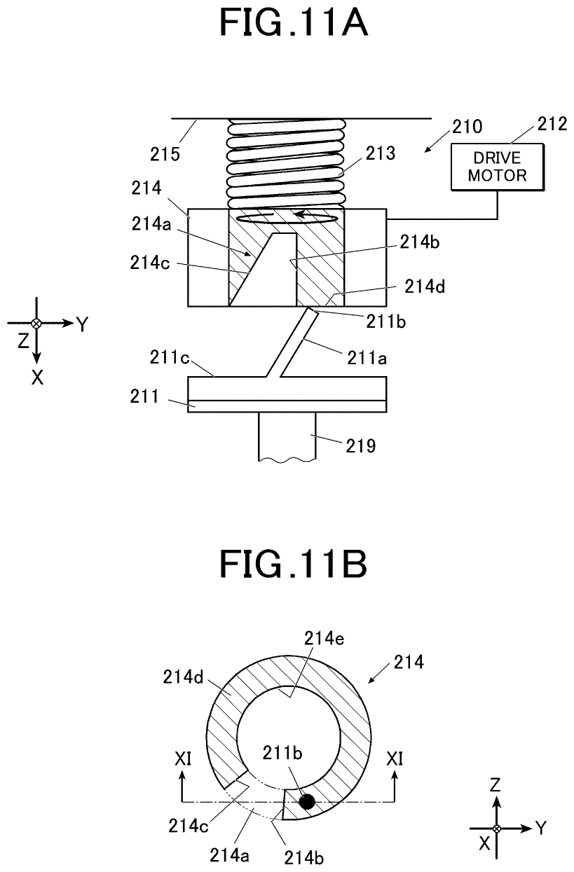

FIG. 11A and FIG. 11B illustrate a state in which the controller 100 has further rotated the drive transmission member 214 in the second direction from the state illustrated in FIG. 10A and FIG. 10B. As illustrated in FIG. 11A, the end part 211b of the engagement portion 211a contacts the facing surface 214d of the drive transmission member 214, and the drive transmission member 214 rotates in the second direction with the elastic member 213 remaining in the most contracted state. The shaded part of the drive transmission member 214 illustrated in FIG. 11A is a sectional view taken along line XI-XI illustrated in FIG. 11B.

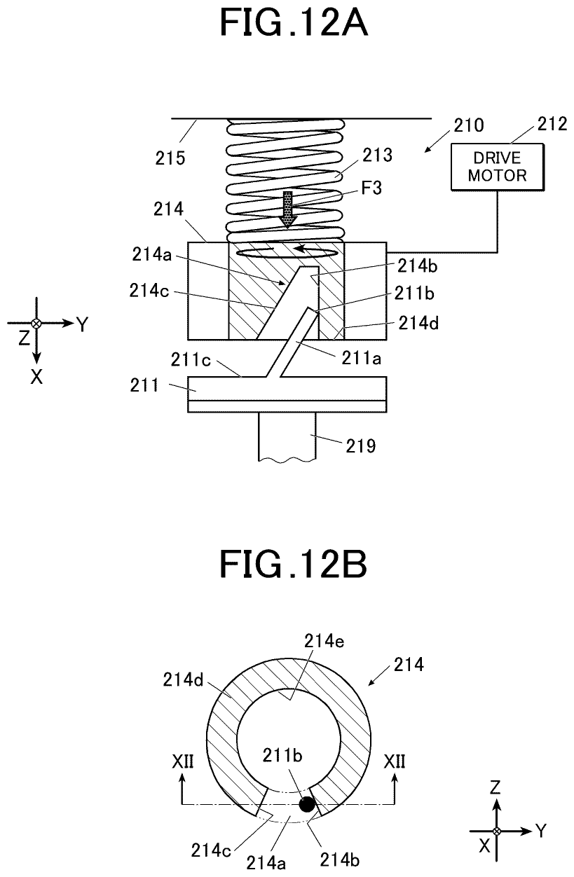

FIG. 12A and FIG. 12B illustrate a state in which the controller 100 has further rotated the drive transmission member 214 in the second direction from the state illustrated in FIG. 11A and FIG. 11B. As illustrated in FIG. 12A, the end part 211a of the engagement portion 211b reaches the position of the parallel part 214b of the engaged portion 214a, and the end part 211b contacts the parallel part 214b. The shaded part of the drive transmission member 214 illustrated in FIG. 12A is a sectional view taken along line XII-XII illustrated in FIG. 12B.

When the end part 211b contacts the parallel part 214b, the contraction of the elastic member 213 is released, and the drive transmission member 214 moves to the positive side of the X-axis direction by elastic repulsive force F3 of the elastic member 213.

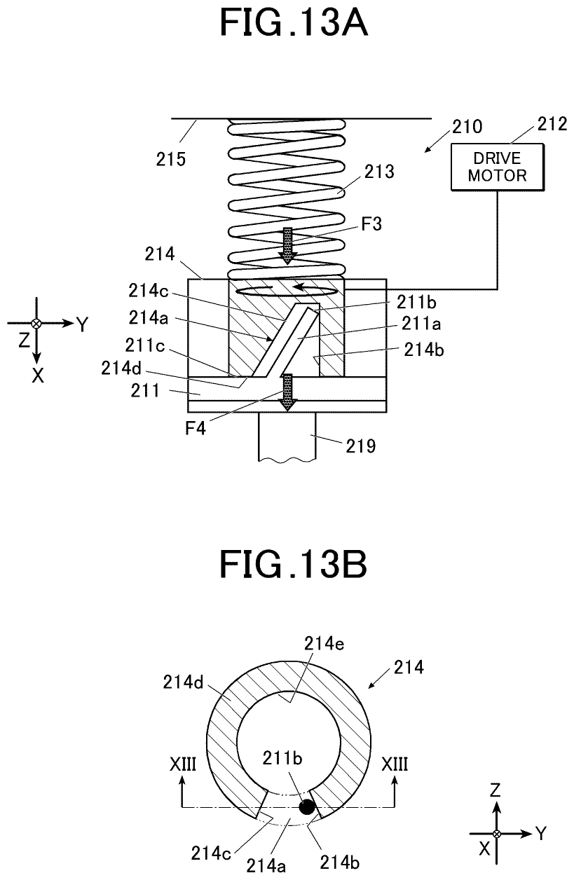

FIG. 13A and FIG. 13B illustrate a state in which the controller 100 has further rotated the drive transmission member 214 in the second direction from the state illustrated in FIG. 12A and FIG. 12B. As illustrated in FIG. 13A, the engagement portion 211a of the idler gear 211 and the engaged portion 214a of the drive transmission member 214 are in the engaged state. The shaded part of the drive transmission member 214 illustrated in FIG. 13A is a sectional view taken along line XIII-XIII illustrated in FIG. 13B.

The drive transmission member 214 further moves to the positive side of the X-axis direction by the elastic repulsive force F3 of the elastic member 213. The drive transmission member 214 collides, at the facing surface 214d, with the facing surface 211c of the idler gear 211. That is, the elastic repulsive force F3 accumulated in the elastic member 213 is released in a short time, so that the drive transmission member 214 collides with the idler gear 211. Thus, the drive transmission member 214 applies an impact force F4 to the idler gear 211.

The vibration due to the impact force F4 received by the idler gear 211 is transmitted to the prevention member 208 via the developing roller 204, the toner supply member 203, the toner conveyance member 202, the developer housing 201, and the like.

When the prevention member 208 vibrates, the toner accumulated on the prevention member 208 is crushed, and the crushed toner is sucked and collected by the suction section 209. Alternatively, the crushed toner adheres to the developing roller 204.

When the controller 100 further rotates the drive transmission member 214 in the second direction from the state illustrated in FIG. 13A and FIG. 13B, the state returns to the state illustrated in FIG. 8A and FIG. 8B. In the states illustrated in FIG. 8A to FIG. 13B, the rotation of the idler gear 211 remains stopped.

The controller 100 keeps rotating the drive transmission member 214 in the second direction, thereby causing the drive transmission member 214 to repeatedly collide with the idler gear 211.

As described above, in the rotation operation in the second direction, the drive transmission member 214 performs a second operation which is an operation of vibrating the prevention member 208 that is provided in the developing device 412 and prevents the toner from being scattered.

The controller 100 rotates the drive transmission member 214 in the second direction and causes the drive transmission member 214 to perform the second operation in the state in which the rotation of the idler gear 211 is stopped.

The drive transmission member 214 can be displaced along the axis direction (X-axis direction) of the idler gear 211. The drive transmission member 214 performs the second operation when displaced from the position in the state in which the engaged portion 214a and the engagement portion 211a are disengaged from each other to the position in the state in which the engaged portion 214a and the engagement portion 211a are engaged with each other.

In the rotation operation in the first direction and the rotation operation in the second direction, the drive transmission member 214 switches and performs the first operation and the second operation.

The controller 100 causes the drive transmission member 214 to switch the first operation and the second operation by switching the rotation direction of the drive transmission member 214. The controller 100 functions as a first controller.

### Second Embodiment

Next, the image forming apparatus 1 according to a second embodiment will be described.

In the following description, the same components as those of the image forming apparatus 1 according to the first embodiment are denoted by the same reference signs, and the description thereof will be omitted.

In the first embodiment described above, when the drive transmission member 214 rotates in the second direction, the load that the toner conveyance member 202 receives from the developer is greater than the conveyance force with which the toner conveyance member 202 conveys the developer by rotating in the second direction. That is, the rotational load of the idler gear 211 in the rotation operation in the second direction is greater than the rotational drive force by the drive motor 212. Therefore, the idler gear 211 does not rotate and remains stopped.

In the second embodiment, it is assumed that, when the drive transmission member 214 rotates in the second direction, the load that the toner conveyance member 202 receives from the developer is less than or equal to the conveyance force with which the toner conveyance member 202 conveys the developer by rotating in the second direction. That is, the rotational load of the idler gear 211 in the rotation operation in the second direction is less than or equal to the rotational drive force by the drive motor 212. In this case, the idler gear 211 and the toner conveyance member 202 rotate in the second direction, and the developer in the developer housing 201 is conveyed in the direction opposite to the direction illustrated in FIG. 4. At this time, the developer in the developer housing 201 is excessively discharged through the discharge port 207a. Thus, when the amount of the developer in the developer housing 201 becomes less than a predetermined amount, the amount of the developer to be supplied to the developing roller 204 becomes insufficient, resulting in the image defect such as screw pitch unevenness. The screw pitch unevenness is density unevenness that occurs in a formed image.

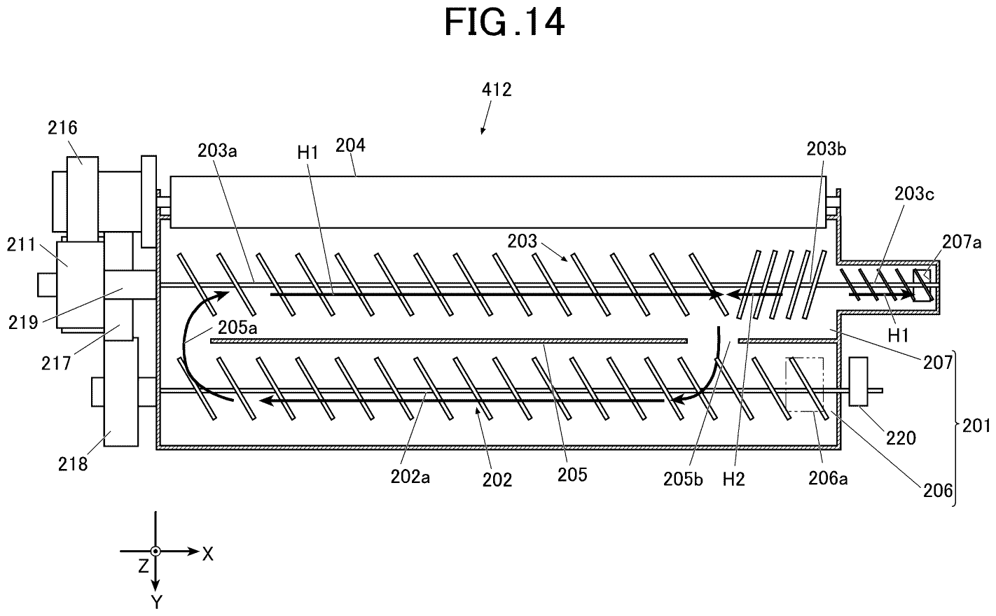

In order to prevent the above-described image defect, the developing device 412 of the second embodiment includes a one-way clutch 220 illustrated in FIG. 14. FIG. 14 is a schematic diagram of the vicinity of the developing device 412 of the second embodiment as viewed from above.

The one-way clutch 220 is provided on the rotation shaft 202a of the toner conveyance member 202 outside the developer housing 201 on the positive side of the X-axis direction, which is opposite to the side on which the idler gear 211 is disposed.

When the drive transmission member 214 rotates in the first direction in the first operation, the one-way clutch 220 does not restrict the toner conveyance member 202 from rotating in the first direction. On the other hand, when the drive transmission member 214 rotates in the second direction in the second operation, the one-way clutch 220 restricts the toner conveyance member 202 from rotating in the second direction. The one-way clutch 220 functions as a restricting member.

Alternatively, the one-way clutch 220 may be disposed on the rotation shaft of the developing roller 204. In this case, when the drive transmission member 214 rotates in the first operation in the first operation, the one-way clutch 220 does not restrict the developing roller 204 from rotating counterclockwise as viewed from the negative side of the X-axis direction. On the other hand, when the drive transmission member 214 rotates in the second direction in the second operation, the one-way clutch 220 restricts the developing roller 204 from rotating clockwise as viewed from the negative side of the X-axis direction.

### Modification Example of Second Embodiment

Next, the image forming apparatus 1 according to a modification example of the second embodiment will be described.

In the following description, the same components as those of the image forming apparatus 1 according to the first embodiment are denoted by the same reference signs, and the description thereof will be omitted.

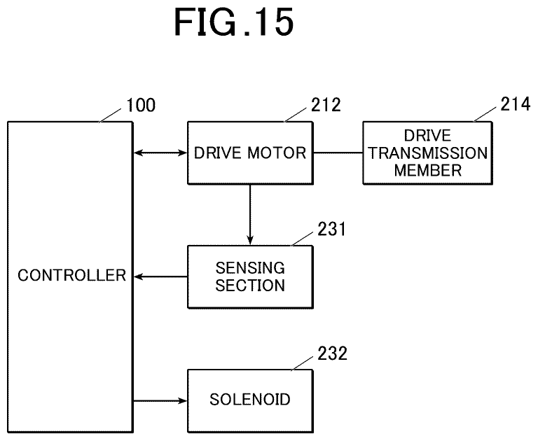

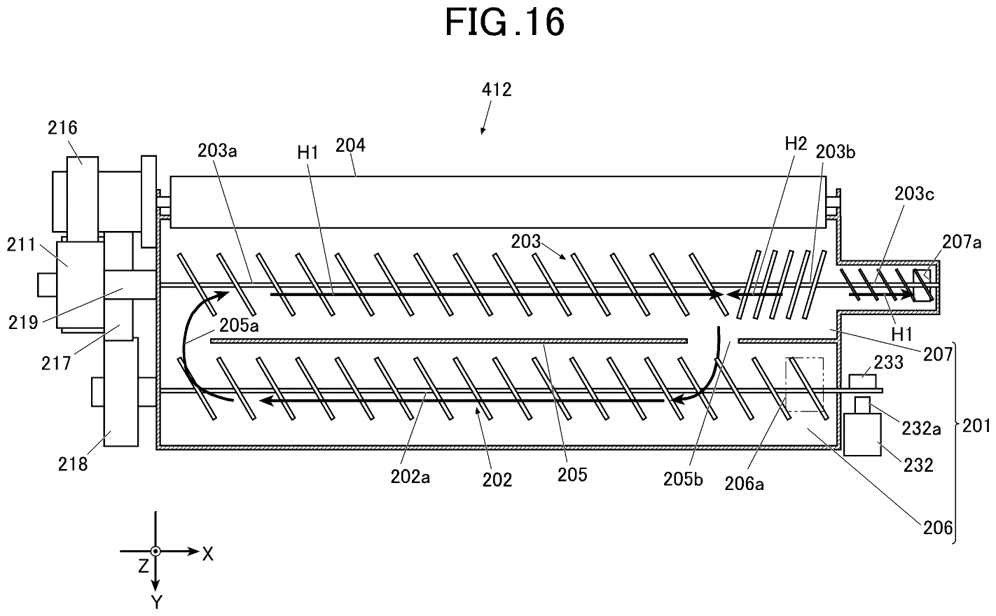

The image forming apparatus 1 of the present modification example includes a sensing section 231 and a solenoid 232 illustrated in FIG. 15, and a protrusion member 233 illustrated in FIG. 16, instead of the one-way clutch 220. FIG. 15 is a block diagram illustrating a control function in a rotation restricting operation of the toner conveyance member 202 of the present modification example. FIG. 16 is a schematic diagram of the vicinity of the developing device 412 of the present modification example as viewed from above.

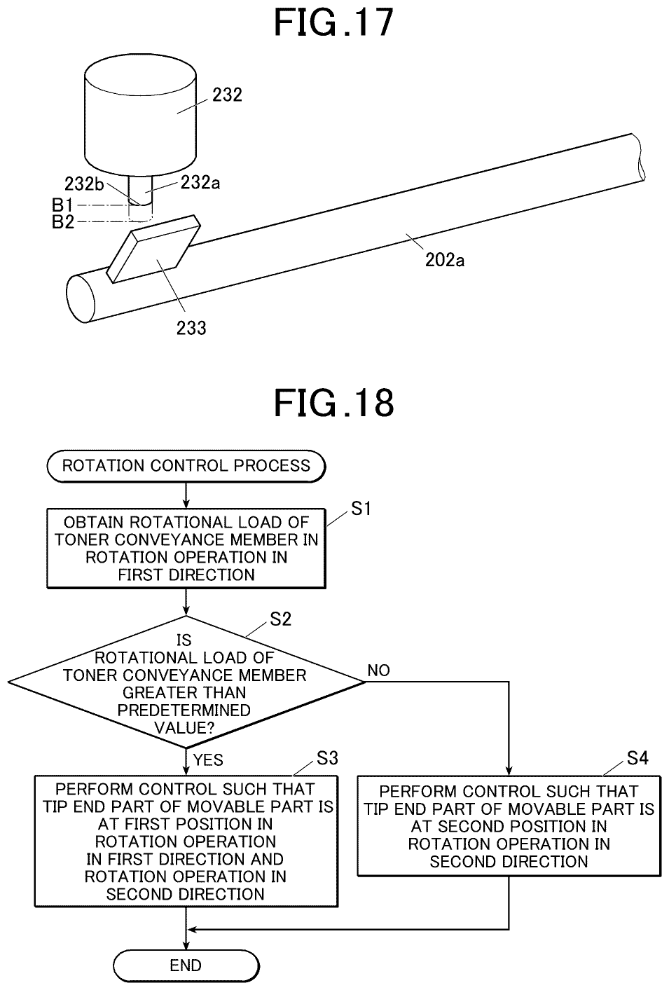

FIG. 17 is a schematic perspective view of the vicinity of the solenoid 232 and the protrusion member 233.

The sensing section 231 senses a load applied to the drive motor 212, thereby sensing a rotational load of the toner conveyance member 202 via the drive transmission member 214 and the idler gear 211. The rotational load of the toner conveyance member 202 is a load that the toner conveyance member 202 receives from the developer stored in the housing chamber 206.

The sensing section 231 outputs the sensed rotational load of the toner conveyance member 202 to the controller 100.

The solenoid 232 and the protrusion member 233 are provided outside the developer housing 201 on the positive side of the X-axis direction, which is opposite to the side on which the idler gear 211 is disposed.

The protrusion member 233 is a plate-shaped member provided on the rotation shaft 202a of the toner conveyance member 202.

The solenoid 232 includes a movable part 232a that is displaceable in the Y-axis direction.

Under the control of the controller 100, the solenoid 232 displaces the movable part 232a such that the tip end part 232b of the movable part 232a is located at a first position B1 or a second position B2.

As illustrated in FIG. 17, in the case where the tip end part 232b of the movable part 232a is located at the first position B1, the tip end part 232b and the protrusion member 233 do not interfere with each other even when the toner conveyance member 202 rotates. Therefore, the toner conveyance member 202 is rotatable. That is, the rotation of the toner conveyance member 202 is not restricted.

On the other hand, in the case where the tip end part 232b of the movable part 232a is located at the second position B2, the tip end part 232b and the protrusion member 233 interfere with each other even when the toner conveyance member 202 attempts to rotate. Therefore, the toner conveyance member 202 cannot rotate. That is, the rotation of the toner conveyance member 202 is restricted.

In the present modification example, the controller 100 performs a rotation control process illustrated in FIG. 18.

### Rotation Control Process

The controller 100 obtains the rotational load of the toner conveyance member 202 sensed by the sensing section 231 during the rotation operation in the first direction (Step S1).

Next, the controller 100 determines whether the rotational load of the toner conveyance member 202 obtained in Step S1 is greater than a predetermined value. The predetermined value is set in advance and is, for example, 500 gf·cm.

The case where the rotational load of the toner conveyance member 202 is greater than the predetermined value (Step S2; YES) will be described. This is a case where, when the drive transmission member 214 rotates in the second direction, the load that the toner conveyance member 202 receives from the developer is greater than the conveyance force with which the toner conveyance member 202 conveys the developer by rotating in the second direction. That is, the case is a case where in the rotation operation in the second direction, the toner conveyance member 202 does not rotate and remains stopped.

In this case, the controller 100 controls the solenoid 232 such that the tip end part 232b of the movable part 232a is located at the first position B1 in the rotation operation in the first direction and the rotation operation in the second direction (Step S3) and ends the rotation control process.

The case where the rotational load of the toner conveyance member 202 is equal to or less than the predetermined value (Step S2; NO) will be described. This is a case where the load that the toner conveyance member 202 receives from the developer when the drive transmission member 214 rotates in the second direction is equal to or less than the conveyance force with which the toner conveyance member 202 conveys the developer by rotating in the second direction.

In this case, the controller 100 controls the solenoid 232 such that the tip end part 232b of the movable part 232a is located at the first position B1 in the rotation operation in the first direction. In addition, the controller 100 controls the solenoid 232 such that the tip end part 232a of the movable part 232b is located at the second position B2 in the rotation operation in the second direction (Step S4) and ends the rotation control process.

That is, in the rotation control process, the controller 100 does not restrict the rotation of the toner conveyance member 202 in the case where the rotational load of the toner conveyance member 202 sensed by the sensing section 231 is greater than the predetermined value. The controller 100 restricts the rotation of the toner conveyance member 202 in the case where the rotational load of the toner conveyance member 202 sensed by the sensing section 231 is equal to or less than the predetermined value. The controller 100 functions as a second controller. The solenoid 232 and the protrusion member 233 function as a restricting member.

Alternatively, the sensing section 231 may sense the rotational load of the developing roller 204 via the drive transmission member 214 and the idler gear 211 by sensing the load applied to the drive motor 212. In this case, the protrusion member 233 is provided on the rotation shaft of the developing roller 204.

In the rotation control process in this case, when the rotational load of the developing roller 204 sensed by the sensing section 231 is greater than the predetermined value, the controller 100 does not restrict the rotation of the developing roller 204. The controller 100 restricts the rotation of the developing roller 204 when the rotational load of developing roller 204 sensed by the sensing section 231 is equal to or less than the predetermined value.

### 6. Others

The developing device 412 may include a seal member such as urethane foam or a soft seal material for preventing leakage of the toner stored in the developer housing 201. The seal member is a soft member capable of filling the gap of the developer housing 201. In a case where the developing roller 204 and the toner conveyance member 202 are connected to the prevention member 208 via the seal member, the vibration due to the impact force F4 transmitted to the developing roller 204 and the toner conveyance member 202 via the idler gear 211 is suppressed by the elasticity of the seal member.

Therefore, it is preferable that the developing roller 204 and the toner conveyance member 202 be connected to the prevention member 208 via a rigid body. In this case, the vibration due to the impact force F4 transmitted to the developing roller 204 and the toner conveyance member 202 is less likely to be suppressed and is efficiently transmitted to the prevention member 208. Thus, the toner accumulated on the prevention member 208 can be efficiently crushed. Examples of the rigid body include a plurality of rigid bodies fastened by a fastening member, and a plurality of rigid bodies bonded and integrated by a curable adhesive or the like.

In the second operation, when the drive transmission member 214 applies the impact force F4 to the idler gear 211, a sound is generated by the impact. The user can recognize that the second operation is being performed by the sound. However, when the surroundings of the image forming apparatus 1 are quiet, the user may be anxious about the sound.

Therefore, in the present embodiment, the drive transmission member 214 performs the second operation at the same timing as a charging cleaning operation performed in the image forming apparatus 1. The charging cleaning operation is an operation in which a charging cleaning member that cleans a charging wire included in the charging device 414 reciprocates in a direction along the charging wire. In the image forming apparatus 1, the controller 100 performs the charging cleaning operation every time printing on 3,000 sheets of paper having the A4 size is performed. The controller 100 performs the charging cleaning operation every time a job is completed.

Thus, the sound generated in the second operation and the sound generated in the charging cleaning operation are generated at the same time. Therefore, the sound generated in the second operation of the present embodiment is not conspicuous.

That is, the second operation of the present embodiment is performed at the same time as an operation different from the second operation performed in the image forming apparatus 1.

The drive transmission member 214 may perform the second operation during the operation of fans included in the image forming apparatus 1. The fans are a fan that prevents a temperature increase in the image forming apparatus 1 and an ozone fan that causes a filter to adsorb ozone generated in the image forming apparatus 1 to perform a cleaning process.

Thus, the sound generated in the second operation and the sound generated by the operation of the fans are generated at the same time. Therefore, the sound generated in the second operation is not conspicuous.

The drive transmission member 214 may perform the second operation during operation of a post-processing apparatus connected to the image forming apparatus 1. The post-processing apparatus is an apparatus that performs post-processing on sheets on which images have been formed, such as stapling, punching, sorting, saddle stitching, and tri-folding.

Thus, the sound generated in the second operation and the sound generated by the operation of the post-processing apparatus are generated at the same time. Therefore, the sound generated in the second operation is not conspicuous.

### 7. Effects

As described above, the image forming apparatus 1 according to the present embodiment(s) includes the developing device 412 that via the toner bearing member (developing roller 204) disposed to face the latent image bearing member (photosensitive drum 413) on which a latent image is formed, makes a toner adhere to the latent image to visualize the latent image.

The developing device 412 includes the drive transmission member 214 that transmits, via the idler drive section (idler gear 211), a drive force for driving the toner bearing member and the toner conveyance member 202 that conveys the toner.

The drive transmission member 214 switches and performs the first operation of transmitting the drive force to the idler drive section to perform the developing process and the second operation of vibrating the prevention member 208 that is provided in the developing device 412 and prevents the toner from being scattered.

Thus, the prevention member 208 can be vibrated by the drive transmission member 214 that transmits a drive force for performing the developing process. That is, a dedicated component for applying vibration to the prevention member 208 is not required. Therefore, it is possible to suppress the image defect due to the toner accumulated in the developing device 412 while suppressing an increase in size or cost of the apparatus.

The image forming apparatus 1 according to the present embodiment includes the first controller (controller 100) that causes the drive transmission member 214 to switch and performs the first operation and the second operation by switching the rotation direction of the drive transmission member 214.

Thus, the first operation and the second operation that is performed by the drive transmission member 214 can be easily switched by switching the rotation direction of the drive transmission member 214.

In the image forming apparatus 1 according to the present embodiment, the first controller (controller 100) rotates the drive transmission member 214 in the first direction in the state in which the engaged portion 214a of the drive transmission member 214 and the engagement portion 211a of the idler drive section (idler gear 211) are engaged with each other. Thus, the first controller causes the drive transmission member 214 to, as the first operation, transmit the drive force greater than the rotational load of the idler drive section to the idler drive section and rotate the idler drive section in the first direction to perform the developing process.

The first controller rotates the drive transmission member 214 in the second direction opposite to the first direction and causes the drive transmission member 214 to perform the second operation in the state in which the rotation of the idler drive section is stopped.

Thus, the first operation and the second operation that are performed by the drive transmission member 214 can be easily switched only by switching the rotation direction of the drive transmission member 214.

The image forming apparatus 1 according to the present embodiment includes the restricting member (one-way clutch 220, or solenoid 232 and protrusion member 233) that restricts the toner bearing member (developing roller 204) or the toner conveyance member 202 from rotating in the second direction when the drive transmission member 214 rotates in the second direction.

Thus, the image defect such as screw pitch unevenness can be prevented from occurring.

In the image forming apparatus 1 according to the present embodiment, the drive transmission member 214 transmits the drive force to the idler drive section via the engaged portion 214a of the drive transmission member 214 and the engagement portion 211a of the idler drive section (idler gear 211) that are engaged with each other in the first operation.

Thus, the drive force for performing the developing process can be transmitted to the idler drive section with a simple configuration.

In the image forming apparatus 1 according to the present embodiment, the drive transmission member 214 is displaceable along the axis direction of the idler drive section (idler gear 211). The drive transmission member 214 performs the second operation when displaced from the position in the state in which the engaged portion 214a and the engagement portion 211a are disengaged from each other to the position in the state in which the engaged portion 214a and the engagement portion 211a are engaged with each other.

Thus, the prevention member 208 can be vibrated with a simple configuration.

In the image forming apparatus 1 according to the present embodiment, the developing device 412 includes the elastic member 213. The drive transmission member 214 performs the second operation using the elastic force of the elastic member 213.

Thus, the prevention member 208 can be vibrated with a simple configuration.

The image forming apparatus 1 according to the present embodiment includes the sensing section 231 that senses the rotational load of the toner bearing member (developing roller 204) or the toner conveyance member 202. The image forming apparatus 1 includes the second controller (controller 100) that does not restrict the rotation of the toner bearing member (developing roller 204) or the toner conveyance member 202 in the case where the rotational load sensed by the sensing section 231 is greater than a predetermined value, and restricts the rotation of the toner bearing member (developing roller 204) or the toner conveyance member 202 in the case where the rotational load is equal to or less than the predetermined value.

Thus, the image defect such as screw pitch unevenness can be prevented from occurring.

In the image forming apparatus 1 according to the present embodiment, the toner bearing member (developing roller 204) and the toner conveyance member 202 are connected to the prevention member 208 via a rigid body.

Thus, the vibration due to the impact force F4 transmitted to the developing roller 204 and the toner conveyance member 202 is hardly suppressed and is efficiently transmitted to the prevention member 208. Thus, the toner accumulated on the prevention member 208 can be efficiently crushed.

In the image forming apparatus 1 according to the present embodiment, the second operation is performed at the same time as an operation different from the second operation that is performed in the image forming apparatus 1.

Thus, for example, when the surroundings of the image forming apparatus 1 are quiet, the sound generated in the second operation does not stand out.

Although specific description has been given above based on the embodiments according to the present invention, the detailed configuration and detailed operation of each device constituting the image forming apparatus 1 can also be appropriately changed without departing from the scope of the present invention.

For example, although the developing device 412 employs a two-component developing method in the embodiments described above, the developing device 412 may employ a one-component developing method.

In the above description, an example in which an HDD, a semiconductor nonvolatile memory, or the like is used as a computer-readable medium of the program according to the present invention has been disclosed, but the present invention is not limited to this example. As another computer-readable medium, it is possible to apply a portable recording medium such as a CD-ROM. Also, a carrier wave is applied as a medium for providing data of the program according to the present invention via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising a developing device that via a toner bearing member disposed to face a latent image bearing member on which a latent image is formed, makes a toner adhere to the latent image to visualize the latent image,
wherein the developing device includes a drive transmission member that transmits, via an idler drive section, a drive force for driving the toner bearing member and a toner conveyance member that conveys the toner, and
wherein the drive transmission member switches and performs a first operation of transmitting the drive force to the idler drive section to perform a developing process and a second operation of vibrating a prevention member that is provided in the developing device and prevents the toner from being scattered.

2. The image forming apparatus according to claim 1, comprising a hardware processor that causes the drive transmission member to switch and perform the first operation and the second operation by switching a rotation direction of the drive transmission member.

3. The image forming apparatus according to claim 2, wherein the hardware processor
rotates the drive transmission member in a first direction in a state in which an engaged portion of the drive transmission member and an engagement portion of the idler drive section are engaged with each other, thereby causing the drive transmission member to, as the first operation, transmit the drive force greater than a rotational load of the idler drive section to the idler drive section and rotate the idler drive section in the first direction to perform the developing process, and
rotates the drive transmission member in a second direction opposite to the first direction and causes the drive transmission member to perform the second operation in a state in which the rotation of the idler drive section is stopped.

4. The image forming apparatus according to claim 3, comprising a restricting member that restricts the toner bearing member or the toner conveyance member from rotating in the second direction when the drive transmission member rotates in the second direction.

5. The image forming apparatus according to claim 1, wherein the drive transmission member transmits the drive force to the idler drive section via an engaged portion of the drive transmission member and an engagement portion of the idler drive section that are engaged with each other in the first operation.

6. The image forming apparatus according to claim 5, wherein the drive transmission member is displaceable along an axis direction of the idler drive section, and performs the second operation when displaced from a position in a state in which the engaged portion and the engagement portion are disengaged from each other to a position in a state in which the engaged portion and the engagement portion are engaged with each other.

7. The image forming apparatus according to claim 1,
wherein the developing device includes an elastic member, and
wherein the drive transmission member performs the second operation using an elastic force of the elastic member.

8. The image forming apparatus according to claim 1, comprising a sensing section that senses a rotational load of the toner bearing member or the toner conveyance member,
wherein the hardware processor does not restrict rotation of the toner bearing member or the toner conveyance member in a case where the rotational load sensed by the sensing section is greater than a predetermined value and restricts the rotation of the toner bearing member or the toner conveyance member in a case where the rotational load is equal to or less than the predetermined value.

9. The image forming apparatus according to claim 1, wherein the toner bearing member and the toner conveyance member are connected to the prevention member via a rigid body.

10. The image forming apparatus according to claim 1, wherein the second operation is performed at the same time as an operation that is performed in the image forming apparatus, the operation being different from the second operation.
